(19) United States
(12) Patent Application Publication
(10) Pub. No.: US 2004/0037760 A1
(43) Pub. Date: Feb. 26, 2004

(54) Steam reforming catalytic reaction apparatus

(75) Inventor: J. Paul Fell, Wall Township, NJ (US)

Correspondence Address: Yuri Kateshov, DILWORTH & BARRESE, LLP, 333 Earle Ovington Blvd., Uniondale, NY, 11553, US

(73) Assignee: ABB LUMMUS HEAT TRANSFER, Bloomfield, NJ

(21) Appl. No.: 10/224,934

(22) Filed: Aug. 21, 2002

(51) Int. Cl. B01J 8/00; F28D 1/00

(52) U.S. Cl. 422/198; 422/190; 422/211; 422/221; 422/196

(57) ABSTRACT

An outlet system in a reforming catalytic reaction apparatus for cracking hydrocarbons for the production of hydrogen (H₂) includes differently dimensioned inlet and outlet reaction tubes attached to and in flow communication with one another; and an external layer of thermal insulation material surrounding a part of the outlet reaction tube

### FIELD OF THE INVENTION

The present invention relates generally to an apparatus for the production of hydrogen by steam reforming. In particular, the invention relates to a furnace outlet system for transferring a stream of reactants including hydrogen from a heating furnace towards a manifold conduit of the apparatus for the production of hydrogen.

### BACKGROUND OF THE INVENTION

Purified hydrogen is an important gas source for many energy conversion process devices and can be produced by a steam reforming process implementing chemical reaction which results in producing hydrogen and certain byproducts or impurities later removed.

Under steam reforming, steam and a hydrocarbon react in the presence of a catalyst. Steam reforming requires elevated temperature, e g, up 1500° F., and produces primarily hydrogen and carbon dioxide. Some trace quantities of unreacted reactants, and byproducts such as carbon monoxide also result from steam reforming.

Typically, the steam reforming process includes distributing a mixture of hydrocarbons and steam over many parallel passes of the catalyst-filled reaction tubes which are subjected to elevated temperatures sufficient to perform the reforming reaction in a primary reformer section. At the furnace outlet system, parallel part streams are passing through downstream portions of the reaction tubes and are further collected in a single stream guided towards a waste heat boiler in which hydrocarbons and hydrogen are quenched for further separation.

Steam reforming catalytic apparatuses are classified as either side-fired or top-fired implement the steam reforming process. A side-firing construction results in long and narrow boxes and often in several furnace boxes that have a common convection bank. Top-fired furnaces, however, can be built for very large capacities just by adding more tube rows in a common box.

Regardless of the type of the steam reforming apparatus, hydrogen purification attempts to always maximize production of hydrogen from the reforming process. To increase the amount of hydrogen obtained, attempts have been made to decrease thermal exposure of the reaction tubes and, thus, to minimize their potential failure.

A structure illustrated in FIGS. 1 and 2 is representative of the steam reforming catalytic reaction apparatus, as disclosed in U.S. Pat. Nos. 3,467,503 and 3,600,141 In particular, the steam reforming catalytic apparatus 10 includes a reaction tube 12 extending through and below the floor of the furnace (not shown) and shaped to conduct a stream of gas mixed with steam through a removable catalyst support grid 16 above where decomposition of hydrocarbons takes place in the presence of a nickel-containing catalyst. A mixture of CO, CO₂, H₂, some other minor reactants, and steam thus leave the furnace and is further conducted through an outlet system into a refractory-lined collector manifold 38 (FIG. 2).

There is no reformer design that can avoid exposing the reformed tubes to very high temperatures approximating 1600° F. as the mixture leaves the furnace. The greater the temperature differential between the inside and outside temperatures, the greater the chance for the tube's failure.

To establish a relatively smooth and gradual temperature transition and to minimize the axial and radial expansion of the reaction tube, its inner surface is lined with a thermal insulating layer. Thus, the inlet reaction tube 12 and an outlet reaction tube 18, which is welded to the inlet reaction tube 12 and to a wall 20 of the collector manifold 38, as indicated by a reference numeral 30, are provided with first 26, second 28, third 32 and forth 34 thermal insulating internal layers. These thermal insulating layers are aligned with one another along a longitudinal direction of the reaction tube between a cone 24 and a lower portion of the outlet reaction tube 18 and are composed of various thermal insulations. Such a structure allows a temperature to decrease gradually from approximately 1600° F. inside the reaction tube to approximately 300° F. corresponding to the outside temperature of the wall.

Still another temperature differential that affects structural integrity of the reaction tube and its expansion in both axial and radial directions is observed between the wall 20 of the collector manifold 38 and the inner space of the collector manifold 38, which is in flow communication with a plurality of the reaction tubes. More particular, the outlet reaction tube 18 is provided with a gas conducting tube 22 positioned centrally and guiding the stream of the reactants and being in flow communication with a plug system 36, which extends into the collector manifold 38. Accordingly, while the wall 20 of the collector manifold 38 is about 300° F., the temperature inside the manifold reaches 1600° F. To minimize the chance of the conduit's failure, its inner wall has a single thermal insulating layer 40.

Overall, the steam reforming catalytic reaction apparatus 10 has a complex structure, which is difficult to assemble and maintain. Numerous internal thermal insulating layers are difficult to install and the reaction tube's shape, which is cylindrical and has a uniform diameter along its entire length, is not instrumental in reducing the gas temperature. Furthermore, a single thermal insulating layer provided on the inner side of the collector manifold is not always sufficient to prevent the overheating of this inner wall.

It is, therefore, desirable to provide a steam reforming catalytic reaction apparatus having a simple, cost-efficient structure, which can be easily assembled and maintained A furnace outlet system facilitating relatively rapid cooling of reactants flowing from the furnace of the steam reforming catalytic reaction apparatus is also desirable.

### SUMMARY OF THE INVENTION

A reforming catalytic reaction apparatus for cracking hydrocarbons for the production of hydrogen (H₂) constructed in accordance with this invention attains these objectives.

In particular, an outlet system of the inventive reaction apparatus has a multiplicity of reaction tubes, each of which includes differently dimensioned inlet and outlet portions attached to and in flow communication with one another.

It is known that radiant heat flux, not reaction kinetics, is the controlling factor in determining the effectiveness of the reaction tubes. The efficient reaction tube heat transfer surface area for the specified average heat flux is associated with the high velocities of reactants guided along the reaction tubes, an optimal volume of catalyst required to affect the endothermic steam reforming reaction and with a relatively uniform, acceptable temperature of the walls of the reaction tubes. A structure of the inventive reaction tube including differently dimensioned portions provides such an effective heat transfer surface area.

In accordance with another aspect of the invention, an outlet portion of a reaction tube is an assembly of an intermediate tube, which extends from the furnace of the reaction apparatus furnace and is provided with at least one external layer of thermal insulating material. The outlet portion further has a bottom tube attached to a collector manifold, which receives multiple streams of reactants exiting a plurality of reaction tubes.

In practice, application of thermal insulating material to the outer surface of the intermediate tube requires a relatively short installation time. Furthermore, by eliminating an inner insulating layer associated with the known prior art, the flow path, along which the reactants flow inside this tube, is straight forward.

According to still another aspect of the invention, the collector manifold is thermally insulated by utilizing multiple internal layers of thermal insulating material

### BRIEF DESCRIPTION OF THE DRAWINGS

The above and other objects, features and advantages will become more readily apparent from the detailed description of the preferred embodiment illustrated by the following drawings, in which:

FIG. 1 is an axial sectional view of an outlet system of a reforming catalytic reaction apparatus for cracking hydrocarbons for the production of hydrogen in accordance with the known prior art;

FIG. 2 is a sectional view of a collector manifold of the reforming catalytic reaction apparatus illustrated in FIG. 1;

FIG. 3 is an axial sectional view of the outlet system of the reforming catalytic reaction apparatus for cracking hydrocarbons for the production of hydrogen in accordance with the present invention;

FIG. 4 is an axial sectional view of the collector manifold of the inventive apparatus shown in FIG. 3; and

FIG. 5 is a cross-sectional view of the inlet portion of the reaction tube of the inventive apparatus shown in FIG. 3.

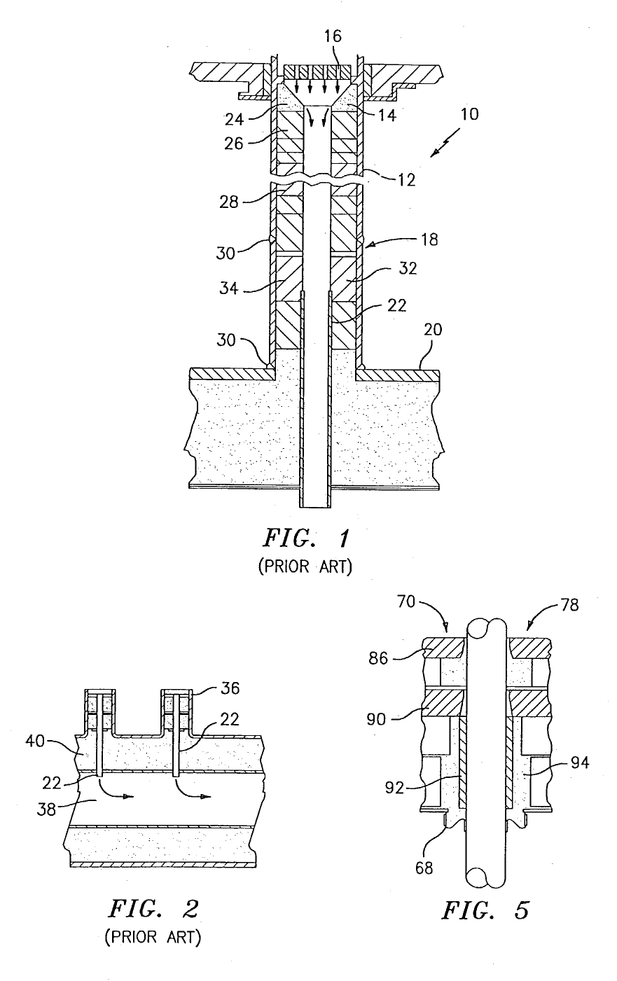

### DETAILED DESCRIPTION OF THE PREFERRED EMBODIMENT

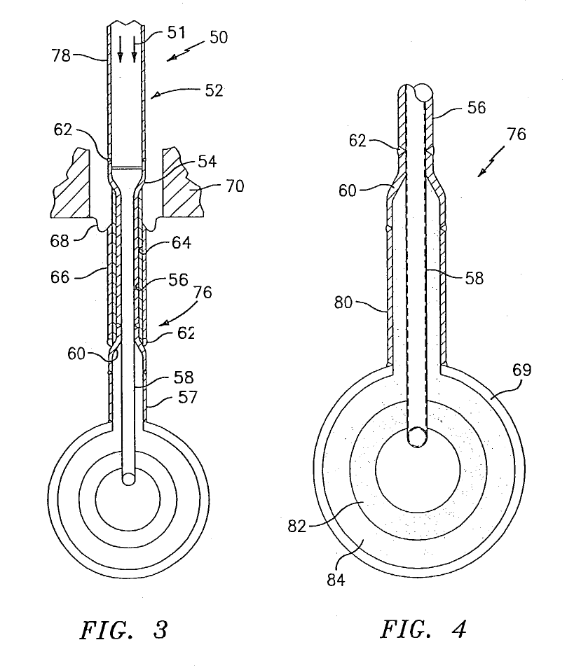

Referring to FIGS. 3-5, a reforming catalytic reaction apparatus 50 for cracking hydrocarbons for the production of hydrogen receives a mixture of a reformable hydrocarbon and steam fed in a direction indicated by arrows 51 as the raw materials (feedstock) into a plurality of reaction tubes Each of the reaction tubes is a combination of an elongated fired portion 52 including a fire tube 78, and an unfired outlet portion 76 having an intermediate tube 56 and a bottom tube 57, which fire 78, intermediate 56 and bottom 57 tubes are spaced apart along a longitudinal direction of the apparatus 50 To provide the reaction tube with an efficient flow velocity, the intermediate tube 56 has an outer diameter which is smaller than a uniform outer diameter of the fire 78 and bottom 57 tubes.

The mixture of hydrocarbon feedstock and steam flows through the catalyst bed supported in the fire box by the reaction tube 78 on a ledge, and as the mixture passes through the catalyst bed, it receives heat from a heating furnace 70. As a result of the endothermic steam reforming reaction, the hydrocarbon feedstock is converted into hydrogen (H₂), carbon dioxide (CO₂) and carbon monoxide (CO), which collectively form a stream of reactants flowing downwards through the outlet portion 76 of the reaction tube at a high temperature of about 1600° F.

An upper cone 54 and a lower cone 60 serve as connecting elements between the fire, intermediate and bottom tubes and are field-welded, as denoted by 62, to opposing ends of these tubes. Due to the geometry of the catalyst tube 78, intermediate 56 and bottom 57 tubes, the upper cone 54 has a peripheral surface converging downwards from the catalyst tube, whereas the lower cone 60 has an inverted structure with a peripheral wall diverging downwards from a lower end of the intermediate tube 56.

The catalyst tube 78 disposed within the heating furnace and terminating approximately at the level of the furnace floor 70 does not have an inner layer of insulating material. However, as shown in FIG. 5, the catalyst tube 78 is thermal insulated along its outer periphery by a multi-layer insulating structure including layers 86, 90, 88 and 94 composed of high temperature cloth seal which is made up of silica inner layer, ceramic fiber and chopped fiber, as well as a firebrick layer 92 The penetration of the inlet portion 52 of the reaction tube through the furnace floor 70 is sealed completely by resilient elements such as flexible bellows 68 allowing the compensating axial and radial thermal expansion of the reactor tube due thermal loads applied to this tube.

As shown in FIG. 3, to minimize thermal effects of heat produced by the stream of reactants that flows along the outlet portion 76 of the reactor tube, the intermediate tube 56 has an external layer 64 of heat insulating material The heat insulating material can be selected from ceramic fiber blanket, chopped fiber, firebrick of their combinations and can include a few sub-layers concentrically attached to one another. The external layers 64 extends preferably between the upper 54 and lower 60 cones and is surrounded by a jacket 66 made from stainless steel. The jacket 66 covers a part of the intermediate tube 56 stretching between the bellows 68 the lower cone 60.

Covering the intermediate tube 56 by the external layer 64 offers a simple and reliable structure reducing a temperature from about 1600° F. inside the reactor tube to about 300° F. on the outside of the external layer 64. Accessible from outside, the external layer can be easily modified by adding additional sub-layers of insulating material. Furthermore, if a reaction tube fails, isolation of tube can be easily provided in a very short down time without cooling down the heating surface by removing the external layer 64, the jacket 66 and either replacing the failed tube with a new one or providing a cap on the bottom tube 57.

The outlet portion 76 has a mixture conducting tube 58 positioned centrally in the bottom tube 57 and projecting into a collector manifold 69 which supports a multiplicity of reaction tubes having a construction identical to the one disclosed above and guides multiple streams of reactants to a waste heat boiler (not shown). The inner surface of the collector manifold 69 is insulated by multiple concentric layers of thermal insulating material including an outer layer 84 and an inner layer 82. The outer layer 84 extends from the collector manifold upwards into a space formed between the mixture conducting tube 58 and the bottom tube 57 and includes insulating quality castable material. The inner layer which has heat-insulating properties inferior to the outer layer 84 is made up of high temperature erosion resistant castable material.

Overall, the reforming catalytic reaction apparatus 50 featuring a combination of the inventive variously dimensioned reaction tube, external layers of thermal insulating material covering the intermediate tube of the outlet portion of the reaction tube and the concentric thermal insulating layers mounted in the collector manifold has a simple structure which is easy to assemble and maintain. The invention is not limited to the disclosed preferred embodiments subject to numerous modifications without, however, departing from the scope of the invention as recited in the following claims.

1. A steam reforming catalytic reaction apparatus for production of H₂, comprising:
a furnace receiving a mixture of a hydrocarbon feedstock and steam and supplying heat for an endothermic steam reforming reaction,
an elongated reaction tube having an inlet portion disposed within the furnace, and an outlet portion extending from the inlet portion below the furnace, the inlet portion being provided with a catalyst bed traversed by the mixture and enabling the endothermic steam reforming reaction to produce a stream of H₂, CO₂ and CO flowing through the outlet portion of the reaction tube;
a collector manifold in flow communication with the reaction tube and attached to the outlet portion for guiding the stream toward a hydrogen extractor; and
an external layer of thermal insulation material surrounding at least a longitudinal part of the outlet portion of the reaction tube.

2. The apparatus according to claim 1, wherein the inlet and outlet portions of the reaction tube include spaced catalyst, intermediary and bottom separate tubes, the bottom tubes having a relatively large uniform outer diameter and the intermediary tube having a relatively small outer diameter.

3. The apparatus according to claim 2, wherein the reaction tube further has an upper cone formed with a downwardly converging peripheral wall extending from an upper end, which is attached to and has an outer diameter substantially equal to the relatively large diameter of the catalyst tube, and a lower end, which is attached to the intermediary tube and has an outer diameter substantially equal to the relatively small diameter.

4. The apparatus according to claim 3, wherein the reaction tube further has a lower cone extending between the intermediary and bottom tubes and formed with a downwardly diverging peripheral wall, which has an upper end attached to the intermediary tube and having an outer diameter substantially equal to the relatively small diameter, and a lower end attached to and having an outer diameter substantially equal to the relatively large diameter of the bottom tube, the upper and lower cones being welded to the respective catalyst, intermediary and bottom tubes.

5. The apparatus according to claim 1, wherein the external layer of thermal insulation material extends between the upper and lower cones.

6. The apparatus according to claim 5, wherein the external layer of thermal insulating material includes multiple concentric layers radially juxtaposed with one another.

7. The apparatus according to claim 6, wherein the external layer of thermal insulating material is selected from the group consisting of ceramic fiber blanket, chopped fiber and a combination of these.

8. The apparatus according to claim 7, further comprising a stainless steel jacket surrounding and attached to the external layer of thermal insulating layer

9. The apparatus according to claim 4, further comprising a mixture-conducting tube positioned centrally in the reaction tube and extending between the lower cone and the collector manifold so that a lower end of the mixture-conducting tube terminates inside of the collector manifold.

10. The apparatus according to claim 1, wherein the collector manifold includes a longitudinal annular pipe extending transversely to a plurality of spaced reaction tubes and has a plurality of concentric layers of thermal insulating material

11. The apparatus according to claim 10, wherein the plurality of concentric layers includes an inner layer made from erosion resistant castable material and an outer layer made from insulating quality castable material.

12. The apparatus according to claim 11, wherein the mixture-conducting tube is spaced radially inwards from the bottom tube so that the bottom and mixture conducting tubes define a space filled with the insulating quality castable material of the outer layer

13. The apparatus according to claim 10, wherein the reaction tubes are welded to the collector manifold.

14. A steam reforming catalytic reaction apparatus, comprising.
a furnace receiving a mixture of a hydrocarbon feedstock and steam and supplying heat for an endothermic steam reforming reaction;
a vertically disposed reformer pipeline extending along an axis and having
a fired catalyst tube projecting through the furnace, an intermediary tube coaxial with and extending downwards from the inlet tube and a bottom tube coaxial with and extending from the intermediary tube, the catalyst, intermediary and bottom tubes being axially spaced from one another and being dimensioned so that the catalyst and bottom tubes have a relatively large uniform diameter and the intermediary tube has a relatively small diameter,
an upper cone having a peripheral wall converging downwards from the fire tube toward the intermediary tube and being attached to the catalyst and intermediary tubes so that the catalyst and intermediary tubes are in flow communication, and
a lower cone having a peripheral wall diverging downwards from the intermediary tube to the bottom tube and being attached to the intermediary and bottom tubes to provide flow communication therebetween;
a catalyst bed mounted in the catalyst tube and traversed by the mixture to enable the endothermic steam reforming reaction to produce a stream of H₂, CO₂ and CO flowing through the intermediary and bottom tubes; and
a collector manifold in flow communication with the reaction tube and attached to the bottom tube for receiving and guiding the stream toward a waste heat boiler

15. The apparatus according to claim 14, further comprising an external layer of thermal insulation material surrounding the intermediate tube.

16. The apparatus according to claim 14, wherein the external layer of thermal insulating material includes multiple concentric layers juxtaposed with one another

17. An outlet system in a reforming catalytic reaction apparatus for cracking hydrocarbons for the production of hydrogen (H₂) comprising:
differently dimensioned inlet and outlet reaction tubes attached to and in flow communication with one another; and
an external layer of thermal insulation material surrounding a longitudinal part of the outlet reaction tube.

18. The apparatus according to claim 17, wherein the external layer of thermal insulating material includes multiple concentric layers juxtaposed with one another

19. The apparatus according to claim 17, wherein the outlet reaction tube includes an intermediate portion surrounded by the external layer of thermal insulation material and a bottom portion spaced from the intermediate portion, the apparatus further comprising a collector manifold in flow communication with the inlet and outlet reaction tubes and attached to the outlet reaction tube, the collector manifold having an inner wall covered by multiple concentric layers of thermal insulation material.

20. The apparatus according to claim 19, wherein the bottom portion of the outlet reaction tube and the inlet reaction tube have a relatively large uniform diameter and the intermediate portion of the of the outlet reaction tube has a relatively small diameter, the apparatus further comprising first and second cones extending between the inlet reaction tube and the intermediate portion and the intermediate portion and the bottom portion of the outer reaction tube, respectively.

21. The apparatus according to claim 16, further comprising a collector manifold in flow communication with the inlet and outlet reaction tubes and attached to the outlet reaction tube, the collector manifold having an inner wall covered by multiple concentric layers of thermal insulation material.
